(19) United States
(12) Patent Application Publication
(10) Pub. No.: US 2002/0092004 A1
(43) Pub. Date: Jul. 11, 2002

(54) Methods and systems for automatically generating software applications

(76) Inventors: John Michael Lee, Lawrenceville, GA (US); John Montague Howard, Decatur, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/916,112

(22) Filed: Jul. 26, 2001

Related U.S. Application Data
(60) Provisional application No. 60/220,754, filed on Jul. 26, 2000.

(51) Int. Cl. G06F 9/45

(52) U.S. Cl. 717/140

(57) ABSTRACT

The present invention provides systems and methods to build multi-tiered software applications with a high level of quality and complexity. One specific embodiment of the system includes a design application that guides a designer through a system design process, a generator application that generates and customizes a software solution tailored to the system design and an installation application that modularizes and automates the installation and configuration of the generated software solution.

### CROSS-REFERENCE TO RELATED APPLICATIONS

This application claims the benefit of priority from the United States provisional application No. 60/220,754, filed on Jul. 26, 2000 and entitled “Methods and Systems For Automatically Generating Software Applications,” the entire contents of which is hereby incorporated by reference.

### FIELD OF THE INVENTION

The present invention generally relates to automatically generating business software with database interaction.

### BACKGROUND OF THE INVENTION

Large-scale software development projects have traditionally been an expensive process fraught with risks. The rapid pace of technological change, scarcity of software developers, complexity of systems, and the vast resources required to develop a software system have all contributed to an estimated software development project failure rate that approaches eighty percent. Moreover, software development is a time consuming process. It is not unusual for a software product to contain hundreds of thousands or even millions of lines of code. The cost to write this code grows exponentially with the amount of code to be developed and with the complexity of the system. Accordingly, businesses are exposed to significant risk when initiating a new software project.

A need therefore exists in the industry for a tool to aid in the development of software applications. While products exist that aid in software system design, they do not provide a complete solution for the application developer. Defining the system design represents only a small percentage of the work required to deliver a complete software application. Many of today's software applications use multi-tier architectures. In a multi-tier system application responsibilities are distributed in distinct layers, often referred to as tiers. For example, a web browser that accesses the application may represent the presentation tier of the system, the compiled code that serves user requests and enforces business rules represents the business tier, and the compiled code that interacts with a relational database management system (RDBMS) represents the data tier.

A need therefore exists for systems and methods that generate complete multi-tiered software applications from design specifications. The system needs to be flexible enough to allow a development team to customize the generated software application, yet sufficiently user-friendly so that the software developers do not have to undergo extensive training to develop an application. The system should reduce the amount of software code that has to be manually written by the developers of the application. This in turn reduces the number of developers required to build the system, which reduces the project cost and addresses the problem of scarcity of qualified developers.

Thus, an unsatisfied need exists for an improved method and system for developing software applications that overcomes deficiencies in the prior art, some of which are discussed above.

### SUMMARY OF THE INVENTION

The present invention provides systems and methods to build multi-tiered software applications with a high level of quality and complexity. One specific embodiment of the system includes a design application that guides a designer through a system design process, a generator application that generates and customizes a software solution tailored to the system design and an installation application that modularizes and automates the installation and configuration of the generated software solution.

In accordance with an embodiment of the present invention, a method is disclosed for automatically generating a software application on a first computer that includes defining a system design, creating a design database file from the system design, converting the design database file to a meta document, generating an installation program from the meta document and installing at least part of the software application by executing the installation program. An additional embodiment is disclosed wherein the installation program is transmitted from a first computer to a second computer. In another disclosed embodiment, the installation program comprises a setup package that automates at least part of the configuration and installation process. In still another disclosed embodiment, the step of defining a system design comprises defining a first entity and at least one attribute associate with that entity. In additional disclosed embodiments, the step of defining a system design also includes defining a second entity and establishing a relationship or a predefined search associated with the entities. In still another disclosed embodiment, the step of installing the software application includes installing a hook in at least one web page and application code configured to process the at least one hook.

In accordance with another embodiment of the present invention, a system is described for developing a computer-generated software application that includes a designer computer, a design application configured to receive a system design and create a design database file, and a generator application configured to receive the design database file and create a computer-generated software application that includes a presentation tier, a business tier and a data tier. In another disclosed embodiment, the system includes a design database configured to receive and store the design database file. And in another disclosed embodiment, the computer-generated application is programmed with object technology.

In accordance with still another embodiment of the present invention, a method for generating a software application is disclosed that includes receiving a system design that defines at least one entity, generating destination directories, generating virtual directories, establishing database connections, creating procedure code, creating controller classes, creating object business code, creating at least one web browser template file, generating security logic and generating a project file.

### BRIEF DESCRIPTION OF THE DRAWINGS

FIG. 1 is a high-level diagram of a software development tool in accordance with an embodiment of the present invention.

FIG. 2 is a high-level block diagram of a process flow to develop a software application using the software development tool in accordance with an embodiment of the present invention.

FIG. 3 is a block diagram of a process flow to define an application in accordance with an embodiment of the present invention.

FIGS. 4a and 4b are screen shots that illustrate the graphic user interface (GUI) that a designer uses to define system entities in accordance with an embodiment of the present invention.

FIG. 5 is a screen shot that illustrates the GUI that a designer uses to define entity attributes in accordance with an embodiment of the present invention.

FIGS. 6a-6c are screen shots that illustrate the GUI that a designer uses to define lookups in accordance with an embodiment of the present invention.

FIGS. 7a-7h are screen shots that illustrate the GUI that a designer uses to define entity relationships in accordance with an embodiment of the present invention.

FIG. 8 is a screen shot that illustrates the GUI a designer uses to define the settings for the appearance of a presentation tier in accordance with an embodiment of the present invention.

FIG. 9 is a screen shot that illustrates the GUI a designer uses to define system generation options in accordance with an embodiment of the present invention.

FIG. 10 is a block diagram of the process flow to generate a software application in accordance with an embodiment of the present invention.

FIG. 11 is a screen shot that illustrates the GUI a designer uses to track the generation of a software application in accordance with an embodiment of the present invention.

FIG. 12 is a block diagram of the process flow to install and customize a generated software application in accordance with an embodiment of the present invention.

FIG. 13 is a screen shot that illustrates the GUI a designer uses to create a setup package in accordance with an embodiment of the present invention.

FIG. 14 is a screen shot that illustrates the GUI a designer uses to initiate an installation of a generated software application in accordance with an embodiment of the present invention.

FIG. 15 is a screen shot that illustrates the GUI a designer uses to setup a server for a generated software application in accordance with an embodiment of the present invention.

FIG. 16 is a block diagram of the process flow of select functions of a generated software application in accordance with an embodiment of the present invention.

FIG. 17 is a screen shot that illustrates the GUI a designer uses for user account management in accordance with an embodiment of the present invention.

FIG. 18 is a screen shot that illustrates the GUI a designer uses to perform an entity search in accordance with an embodiment of the present invention.

FIG. 19 is a screen shot that illustrates the GUI a designer uses to edit an entity in accordance with an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

A. Architecture

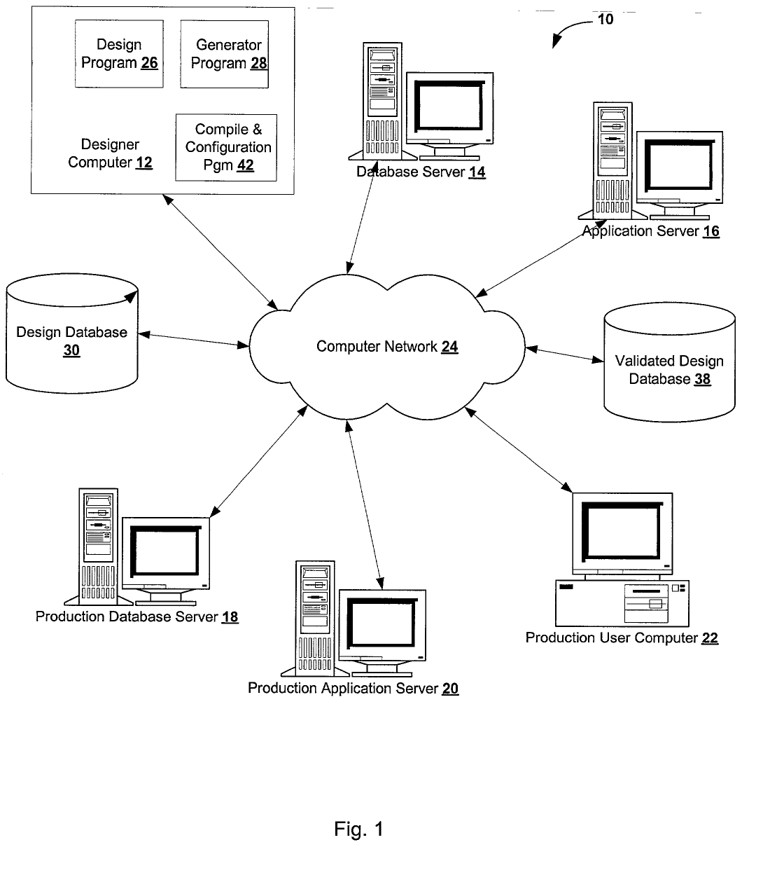

FIG. 1 is a high-level diagram of a software development tool 10 for practicing various aspects of an embodiment of the present invention. In this embodiment, the present invention includes a designer computer 12, a database server 14, an application server 16, a production database server 18, a production application server 20 and a production user computer 22, each in electronic communication via a common computer network 24. In the disclosed embodiment, the network 24 is a internal computer network. But it will be readily apparent to one of ordinary skill in the art that the present invention may be implemented in any networked environment including the Internet.

In addition, in a preferred embodiment, a design program 26 and a generator program 28 reside on the designer computer 12 and a design database 30 and generated system database 32 (not shown) are accessible by the above-described system components via the network 24. It will be readily apparent to one of ordinary skill in the art however that one or more of these applications can reside on separate servers or on other electronic devices.

The operation of the software development tool 10 is described in greater detail below. In general, however, a designer or an automated computer system uses the design program 26 to create a system design for a new software application. Through a user-friendly graphic user interface, the design program 26 prompts the designer for elements of the system design and stores those elements as a design database file 34 which is stored in the design database 30.

In a preferred embodiment, the design database file 34 created by the design program 26 is passed to the generator program 28 where it is reformatted as an extensible markup language (XML) meta document. In an alternative embodiment, two database design files 34 can be spliced to create a new database design file 34. In designing a new application, it is often useful to reuse successful designs from previous applications. The design program 26 allows the designer to import parts of another system design into the database design file 34 on which the designer is currently working. The two system designs are effectively spliced together. In alternative embodiments, additional system designs are spliced into the working design. This allows for the generation of applications that implement superior designs from other applications known in the art. Thus, in an alternative embodiment, the generator program 28 accepts as input an XML meta document containing system design information that was created by one or more third-party applications.

In another embodiment, XML meta documents 36 generated by universal modeling language (UML) applications are converted into design database files 34, and then into full applications. UML is a set of conventions that are well known in the art for diagramming applications. UML applications, used to develop application designs, generally are able to create XML meta documents 36 of these designs. These XML meta documents 36 may then be imported into the generator program 28 and used to generate new validated design database files 38. And in yet another embodiment, the generator program 28 may accept as input an XML meta document that contains system design information generated by the design program 26 as well as one or more third-party applications.

Furthermore, in another embodiment, the design program 28 analyzes the structure of mainframe applications that use DB2 or similar legacy technologies, as well as small database applications that use technologies such as Paradox, MS Access and MySQL. After analysis, these databases are converted into design database files 34 that are sent to the generator program 28. In this way, the software development tool 10 may be used to generate new software applications from existing, and often outdated, databases.

Upon receipt of a XML meta document, the generator program 28 performs a series of validation routines on the XML meta document to ensure that the data contained therein comports with the system requirements of the software development tool 10. If the system design data passes the validation routines, the generator program 28 creates a validated design database file 38 and a system installation program 44, which, in a preferred embodiment, is then sent to the production user computer 22. The execution of the system installation program 44 generates a generated software application 40, components of which, in a preferred embodiment, span the production user computer 22, production application server 20 and production database server 18.

In a preferred embodiment, the generated software application 40 follows a multi-tier application approach and includes software code to define a database (data tier), code to define business services (business tier) and code to dynamically create a GUI (presentation tier).

A designer may install and configure the generated software application 40 using a compile and configuration program 42 (not shown). In a preferred embodiment, the compile and configuration program 42 resides on the designer computer 12 and generates a user-specific system installation program 44 that is customized to install the generated software application 40. Also in a preferred embodiment, the system installation program operates on the application server 16. But it will be readily apparent to one of ordinary skill in the art that the compile and configuration program 42 and the system installation program 44 can reside and/or operate on other servers or on a stand-alone electronic device. Upon execution, the system installation program 44 installs the components of the generated software application 40 onto the production database server 18 and production application server 20. Once installed, system users, including individuals and/or automated computer systems, access the operating version of the generated software application 40 through the designer computer 12 or the production user computer 22 and connect to the production application server 20 over the network 24.

B. Operation

The following paragraphs describe an embodiment of the present invention in the context of generating a software application to track medical information. Specifically, in the described embodiment, the software development tool 10 generates a software system to track information such as patient contact data, allergies and medications. The following embodiment is merely illustrative and it will be readily apparent to one of ordinary skill in the art that the methods and systems described herein may be used to create other applications as well.

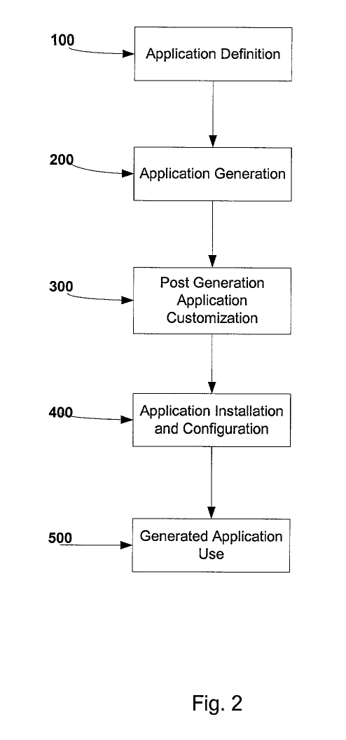

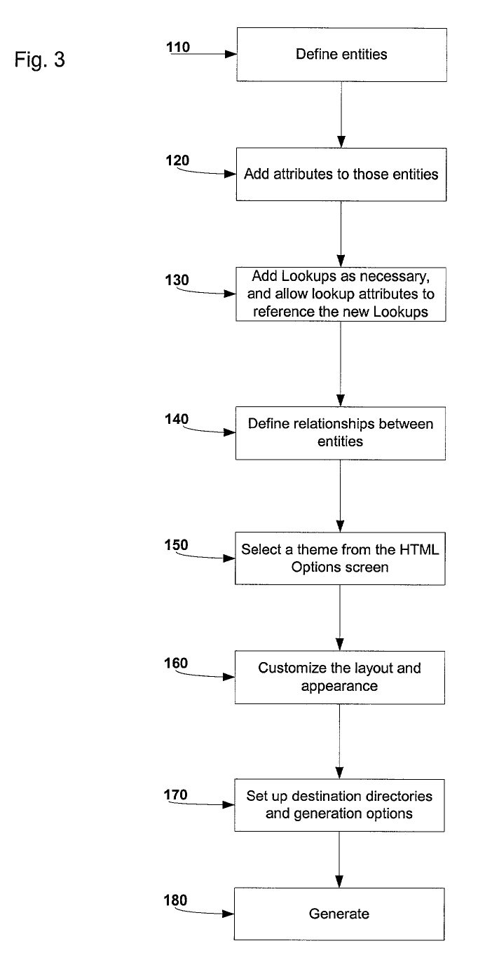

FIG. 2 is a high-level block diagram of a process flow to develop a software application using a software development tool 10 in accordance with an embodiment of the present invention. In Step 100 the system application to be generated is defined. The process of application definition involves several steps, which are illustrated in the block diagram of FIG. 3. In Step 110, a designer defines system entities 50 through the design program 26 residing on the design computer 12. System entities 50 are well known in the art and generally refer to anything about which information can be stored; for example, a person, concept, physical object or event. An object is an instantiated version of an entity and defines a specific instance of the entity 50. For example, a country can be a specific type of entity 50, with the United States as a specific instance of the country entity. And a software object in memory that represents the United States would be an instantiated version of the entity.

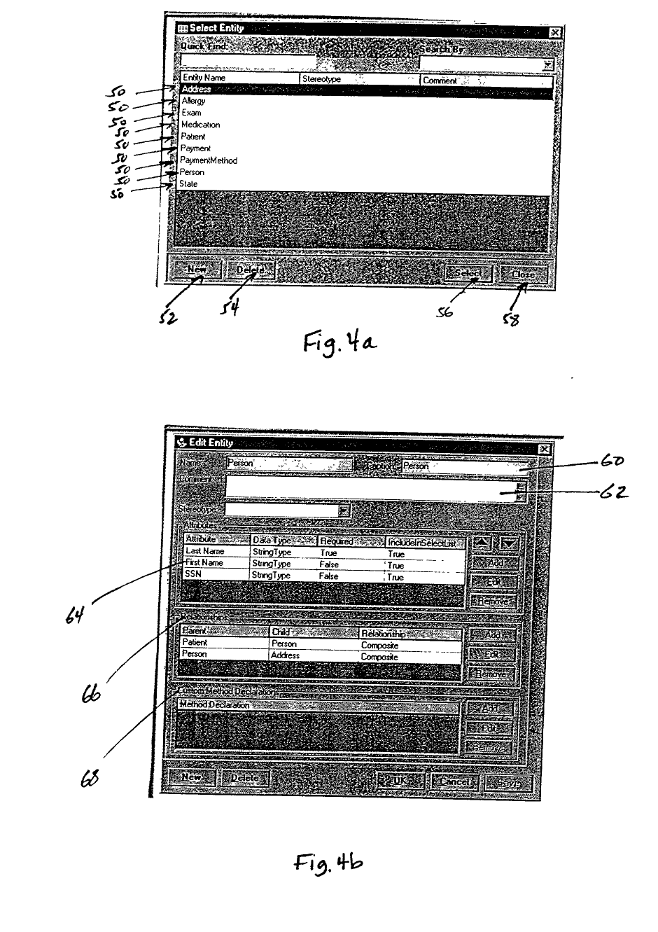

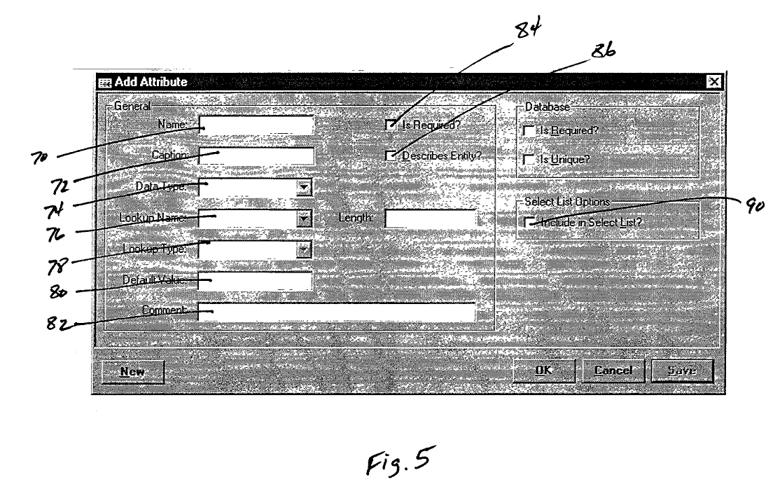

FIGS. 4a and 4b are screen shots that illustrate the GUI that the design program 26 might use to prompt a designer to enter system entities 50. FIG. 4a displays a list of entities 50 in accordance with the disclosed embodiment. In this figure, the designer may add additional entities 50 via the new button 52, delete an existing entity 50 via the delete button 54, select one of the listed entities 50 via the select button 56 or close the application via the close button 58. If the designer selects an entity 50 via the select button 56 or by double clicking on an entity 50, the designer will see a GUI such as that shown in FIG. 4b. When defining or editing an entity 50, a designer can specify multiple settings about the entity 50. In a preferred embodiment, the entity 50 settings that may be changed include screen captions 60, comments 62, attributes 64, relationships 66 (between entities) and custom method declarations 68. A screen caption 60 defines textual information that is displayed on the GUI. Comments 62 within this context refer to textual descriptions of a software module, object or program as stored within the object code of the generated software application 40. An attribute 64 is a descriptor of an entity 50 and is described more fully in the following paragraphs.

Returning to FIG. 3, in Step 120 attributes 64 are added to the entities 50. FIG. 5 is a screen shot that illustrates the GUI that the design program 26 might use to aid the designer in defining attributes 64 for the defined entities 50. As shown in the embodiment of FIG. 5, a designer may define many properties of an attribute 64. In this embodiment, the definable properties include an attribute name 70, attribute caption 72, data type 74, lookup name 76, default value 78 and attribute comment 80. An attribute caption 72 is textual description that will be displayed on a user screen in the presentation GUI. The data type 74, in this example, is one of a string, date, long integer or short integer. The lookup name 76 is a reference to another entity 50 within the system and is implemented as a foreign key with the generated database (described below). The lookup type 78 determines the display method for the lookup list, whether a drop-down list, an option group, or a pop-up screen. The default value 80 is the value the attribute 64 will use unless set otherwise by the system and/or the designer. And the attribute comment 82 is the textual description of the attribute that is stored in the object code of the generated software application 40.

FIG. 5 also includes a required attribute check box 84 that, when enabled, requires the designer to enter a value for the particular attribute 64. A describes entity checkbox 86 allows the designer to set this attribute's value as part of a descriptor for the attribute's entity. This property is especially used within the context of error-handling and defect repair of problems within the object code of the generated software application 40. An attribute length field 88 is shown that allows a designer to specify the maximum length of the attribute's value. In addition, the designer can specify whether to include the attribute within a search screen for the entity 50 by checking the include in select list box 90. and unique constraints for the attribute 64, within the scope of the particular entity of which the attribute 64 is a member can be selected via the database required box 92 and the database unique box 94.

Returning again to FIG. 3, in Step 130 the 26 the designer creates lookups 96 and creates a reference from attributes 64 to the lookups 96. A lookup 96 is a predefined search on an entity 50. The lookup 96, in turn, points to another entity 50 from which it retrieves lookup data. As an example, if a system design includes a ‘HomeAddress’ entity 50 and the system is designed to require that a designer choose a home state from a preset list of two letter state abbreviations, a state entity 50 must be created that contains an abbreviation attribute 64. The abbreviation attribute 64, in turn, would be defined to contain the two letter abbreviation for each state. A lookup 76, entitled for example ‘TwoLetterStateLookup,’ would then be defined to point to the abbreviation attribute 64 of the states entity 50. And the home state attribute 64 of the ‘HomeAddress’ entity 50 would reference the ‘TwoLetterStateLookup’ lookup 76.

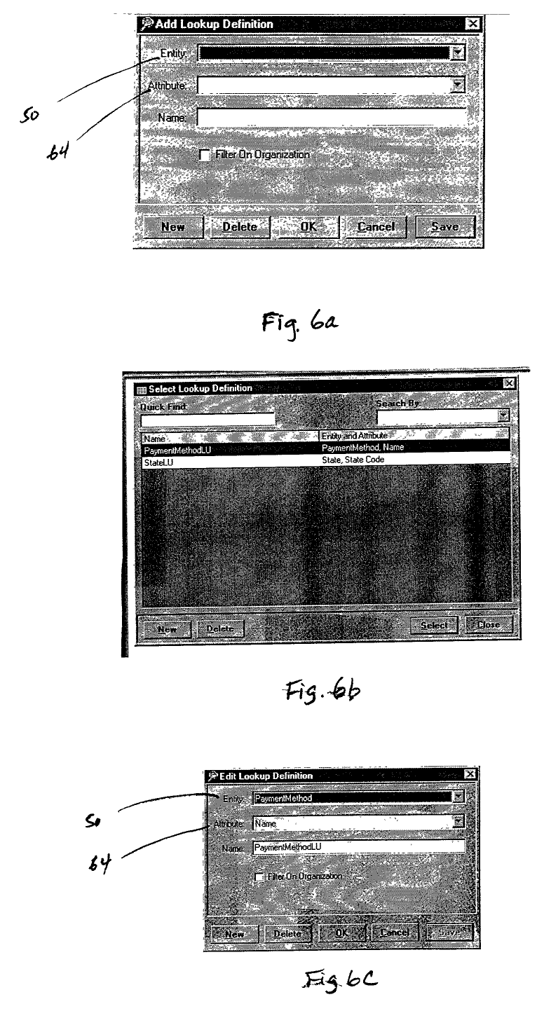

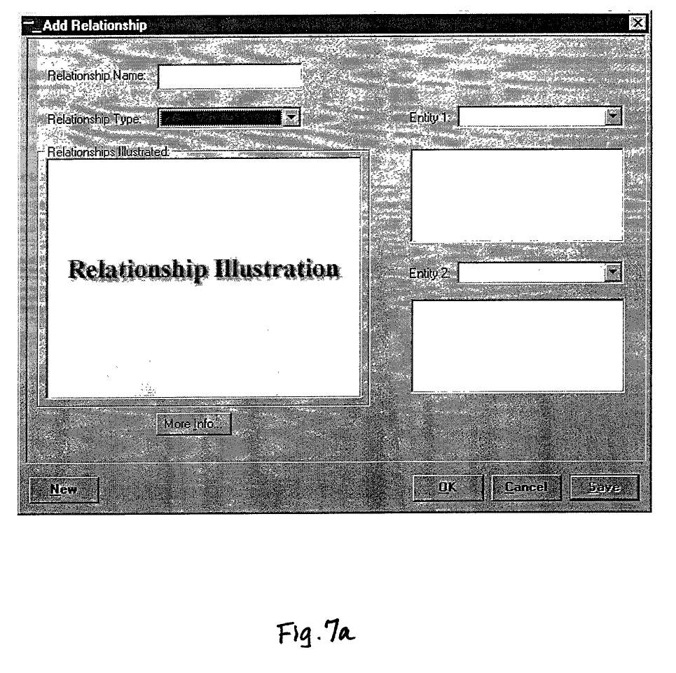

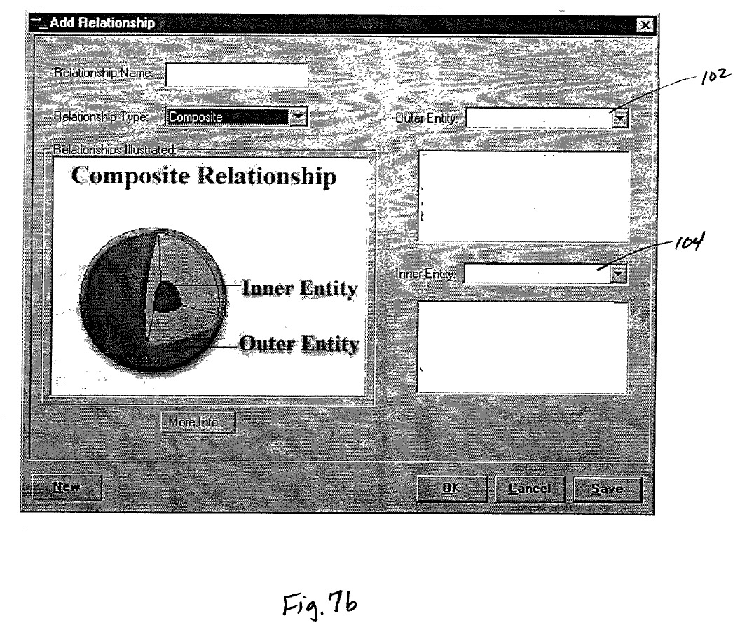

FIGS. 6a, 6b and 6c are screen shots that illustrate a GUI that a display program 26 might use to allow a designer to add lookups 96 in accordance with an embodiment of the present invention. FIG. 6a shows a screen that prompts a designer to define a new lookup 96. In FIG. 6b, exemplary lookups 96 entitled payment method lookup and state lookup are listed. Finally in FIG. 6c, the payment method lookup is displayed in an edit lookup screen.

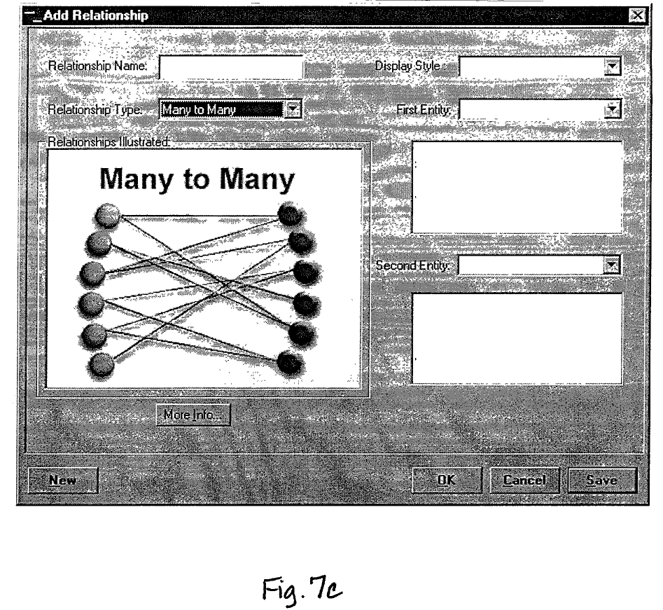

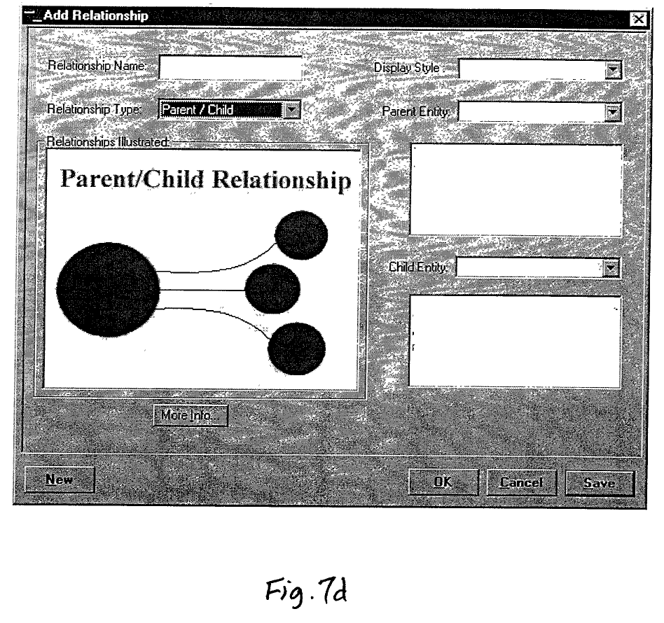

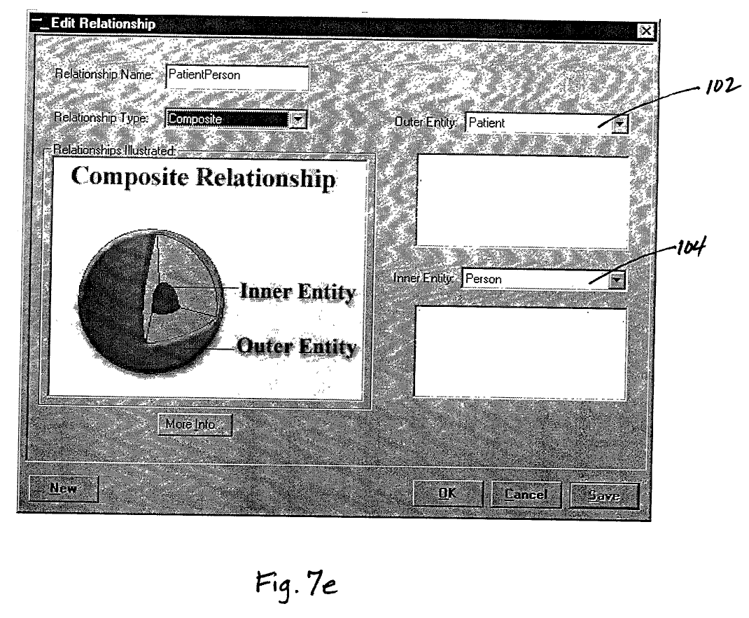

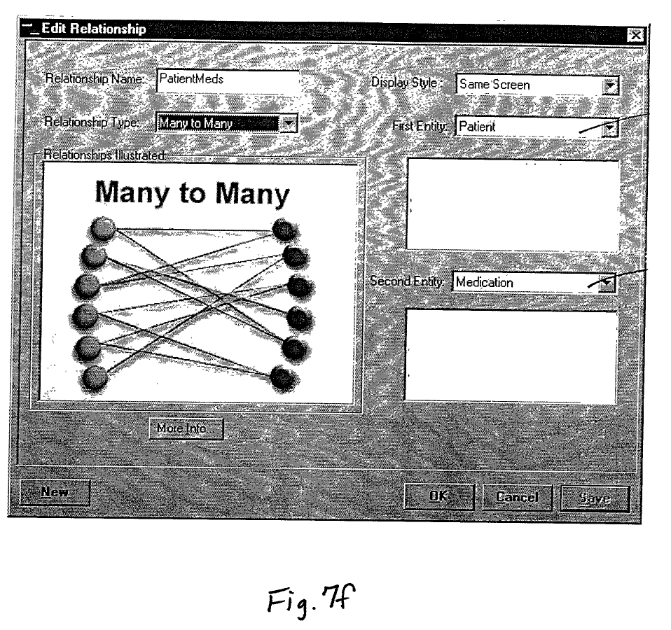

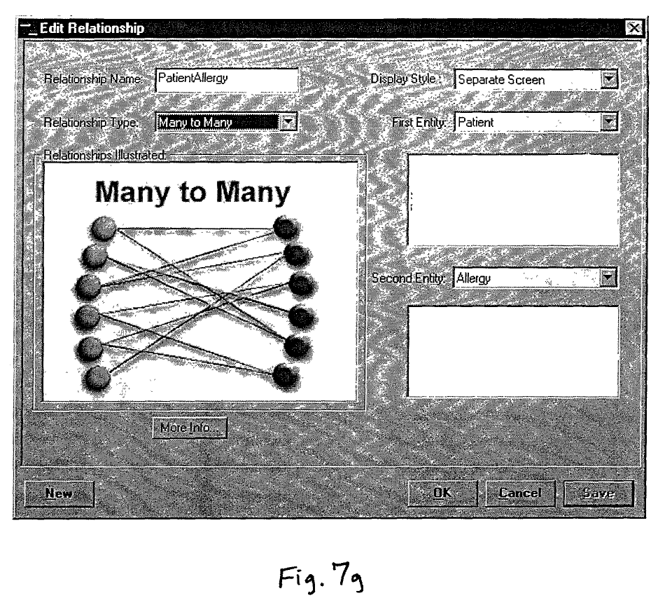

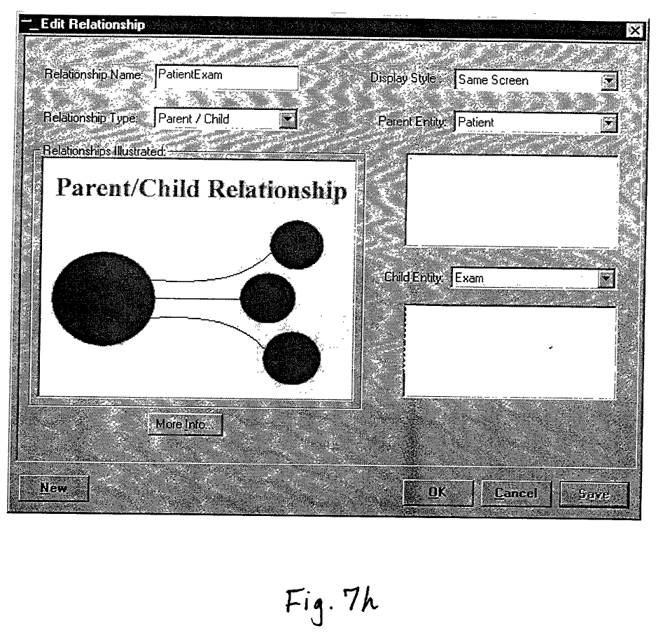

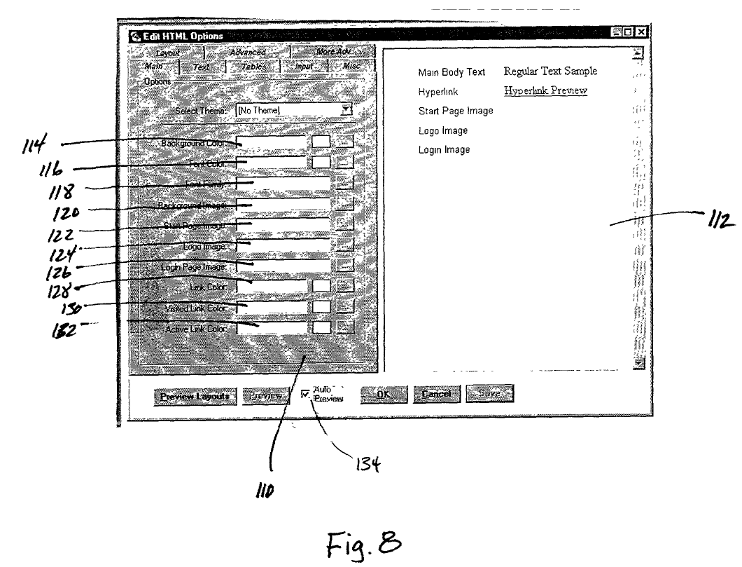

Returning again to FIG. 3, in Step 140 the design program 26 prompts the designer to define the relationships 66 between the entities 50. Relationships 66 between entities refer to relationships as are well known in the art and in relational database nomenclature. FIGS. 7a through 7h are screen shots that illustrate a GUI that a display program 26 might use to allow a designer to define the relationships 66 between the entities 50. FIG. 7a shows a screen that prompts a designer to define a relationship between a first and second entity 50. Included in FIG. 7a are fields for relationship name field 98 and relationship type 100.

In a preferred embodiment in accordance with the present invention, possible relationship types include a composite relationship (FIG. 7b), a many to many relationship (FIG. 7c) and a parent/child relationship (FIG. 7d). Composite relationships between entities 50 are well known in the art and involve the situation where one entity 50 is composed of another entity 50. A related term, inheritance, is also known in the art and means that one entity 50 receives the properties and methods of another entity 50. FIG. 7e illustrates a typical composite relationship that a designer may define in the context of the medical information tracking system in accordance with the disclosed embodiment of the present invention. In this example, a patient entity is defined as the outer entity 102 and a person entity is defined as an inner entity 104. As a result of the composite relationship, the patient entity automatically receives access to the properties and methods of the person entity.

Many to many, or associative, relationship types are also well known in the art and involve the situation where two entities 50 have one to many relationships with each other. FIG. 7c illustrates a screen in which a designer is prompted to define a many to many relationship between a first and second entity. Included in the figure is prompt for a user-defined display style 102 that allows a designer to define a display style 102 for data within the relationship 66. FIGS. 7f and 7g illustrate typical composite relationships that a designer might define in the context of the medical information tracking system. In this example, a many to many relationship is established between the patient entity and the medication entity in FIG. 7f and another many to many relationship is established between the patient entity and the allergy entity in FIG. 7g.

As is well known to one of ordinary skill in the art, many to many relationships 66 model situations where different objects use one another. As a simple example of a many to many relationship 66, consider that one person may read many magazines and one magazine may be read by many people. If this relationship were modeled, a system would be designed create a many to many relationship between the person entity 50 and the magazine entity 50. If a software application were generated from this entity structure, the user of the application could view the magazines read by a selected person or the persons that read a selected magazine.

The parent/child type of entity relationship is also well known in the art and involves the situation where a one to many relationship exists between a first and second entity. As with the many to many relationship, the designer in the disclosed embodiment may define a display style 102 for data within the parent/child relationship. FIG. 7h illustrates a typical parent/child relationship that a designer might define in the context of the medical tracking system. In this example the patient entity is defined as the first entity 106 and the exam entity is defined as a second entity 108 because a given examination is unique to a patient while the patient may have multiple examinations. This relationship is different from a one to many relationship in that it constrains the way data is handled. For example in the context of the medical tracking application of the disclosed embodiment, a parent/child relationship 66 between a patient entity 50 and an examination entity 50 can be used to prevent the same examination time from being scheduled for multiple patients.

In a preferred embodiment, an additional step in the entity definition process described above is to prompt the designer to define custom methods for an entity 50. A method is well known in the art as an action that an object can perform. In a preferred embodiment, the generator program 28 defines multiple method declarations for every entity 50 as part of the generated software application 40 and the designer has the option of create non-standard or custom methods within the design program 26 via the custom methods declaration setting 68.

Returning again to FIG. 3, once the system entities 50 are defined, the design program 26 prompts the designer to begin defining settings for the appearance of the presentation tier. In Step 150, the designer is prompted to select a theme from the hypertext markup language (HTML) options screen. FIG. 8 is a screen shot that illustrates a GUI that a designer use in Step 150. The HTML option screen is separated into two areas: the HTML options area 110 and the HTML display area 112. In a preferred embodiment, HTML user options that are presented in the HTML options area 110 include background color 114, font color 116, font family 118, background image 120, start page image 122, logo image 124, login page image 126, link color 128, visited link color 130 and active link color 132. In the preferred embodiment, as the designer changes the HTML user options, the changes are reflected real-time in the HTML display area 112. In an alternative embodiment, the changes are not reflected in the HTML display area unless an HTML auto preview box 134 is enabled.

Returning again to FIG. 3, in Step 160 the designer program 26 prompts the designer to select the settings for the GUI layout. In a preferred embodiment, the designer may select settings for the GUI layout using a HTML layout preview screen 136. An HTML layout preview screen allows the designer to make additional modifications to the presentation tier by modifying the positioning of web elements on the web screen. In addition, prior to generation, the designer may also define custom presentation templates. In a preferred embodiment, the designer will be able to configure the appearance and location of all web elements viewed by the end user. As a non-limiting example, a user may configure font types, font colors, font sizes, background textures and border styles.

These steps allow the designer to define the type of presentation used by the generated software application 40. The presentation code generated produces the GUI that allows the end user to interact and use the generated software application 40. In a preferred embodiment, the presentation options, including the HTML and GUI layouts, selected by the designer determine the presentation code that is generated in the generated software application 40. Similarly, the entity 50, attributes 64, relationships 66 and lookups 76 defined by the designer using the design program 26 determine the business rules of the system design and affects the business and data code that will be generated. Thus, through the herein described steps, a designer using the software development tool 10 of the present invention can generate a multi-tiered software solution to a system design that integrates and allows interaction between presentation code, business code and data code.

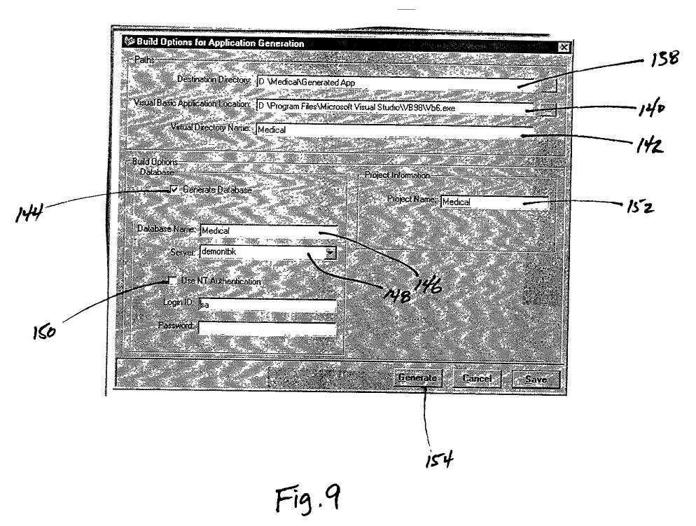

In Step 170 of the disclosed embodiment, the designer program 26 prompts the designer to define the options related to the system generation process. In a preferred embodiment, the system generation options that a designer may configure are illustrated in FIG. 9 and include a destination directory 138 for the generated software source code, a visual basic application location 140, a virtual directory name 142, a generate database flag 144 that determines whether the generator program 28 will create a database as part of the generated software application 40, a generate database name 146, a generate database server 148 on which the generated database will reside, an NT security option 150 that provides secure access to the database server and a project name 152 for the business services object code software project. In the preferred embodiment, visual basic software code is generated for the business tier. In alternative embodiments, the generator program 28 will generate software code using other programming languages that include, without limitation, extensible markup language (XML), structured query language (SQL), ActiveX data objects (ADO), visual basic, JavaScript and HTML. Additional embodiments of the present invention can include other programming languages that are well known in the art.

Returning to FIG. 3, in Step 180 the designer initiates the generation of the generated software application 40. In a preferred embodiment, a generate button 154 is included among the system generation options of FIG. 9. When the generation process is activated, the design program 26 communicates with the design database 30 and passes the system design to an XML meta document 36. The generator program 28 receives the XML meta document containing the system design specifications and runs a series of validation routines to confirm that the system design data conforms to the requirements of the software development tool 10.

As indicated previously, in a preferred embodiment the system design data has been inputted by a designer via the design program 26 and is formatted as a design database file 34. In alternative embodiments, however, the system design specifications may have been created by a third-party application or generated from an existing database. In still other embodiments, a XML meta file may contain design specifications created by a combination of the design program 26, third-party applications and existing databases. In the alternative embodiments, since third-party applications and/or data are involved, the validation routines of the generator program 28 become especially important, as the system design data may not be properly formatted.

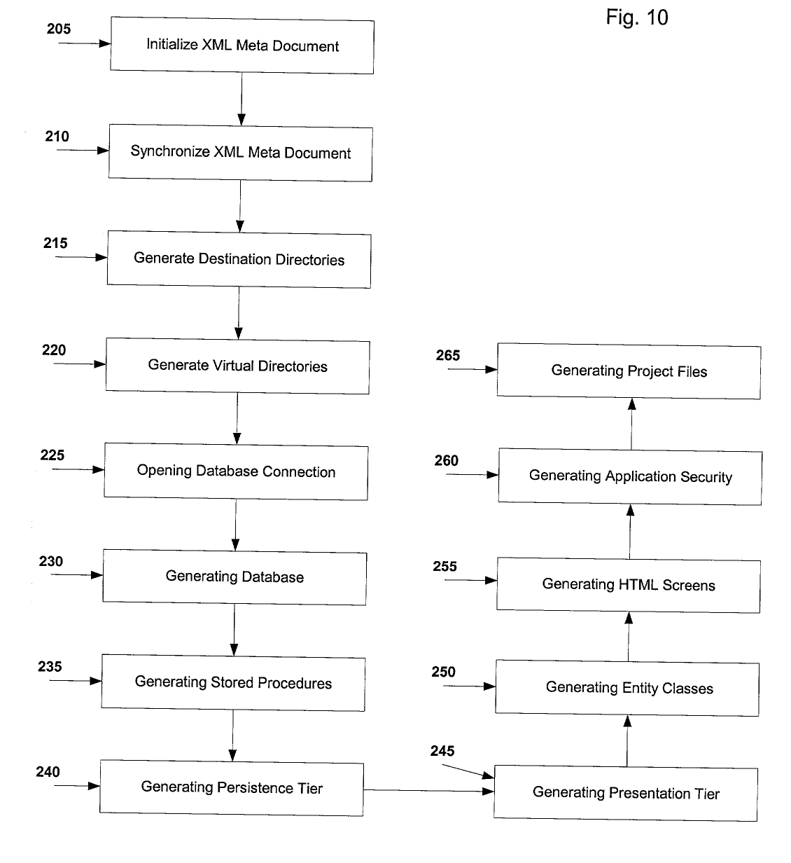

Returning to the high-level block diagram of FIG. 2, the application is generated in Step 200. In a preferred embodiment, the application generation process involves several steps, which are illustrated in the block diagram of FIG. 10. In Step 205, the XML meta document 36 is initialized. In this step, the generation program 28 validates the system design data entered by the designer and, if any of the system design data is not properly formatted, the generator program 28 notifies the designer of the error. If the system design data is valid, 156 an XML meta document 36 is created with the entities 50, attributes 64, lookups 96, relationships 66, presentation settings established by the designer.

In Step 210, the generator program 28 synchronizes the XML meta document 36. In a preferred embodiment, the synchronization process of Step 210 allows the generator program to accept XML meta documents from multiple sources including the design computer 26 (via a design database file 34), a third-party application design tool and/or an existing system or database. The process of reading a system design from a first design database file 34, writing the system design to an XML meta document 36 and converting the XML meta document 36 into a validated design database file 38 provides the software development tool 10 the flexibility to generate software applications from system designs created by outside sources. In alternative embodiments, this process can allow multiple designers to use the design program 28 to concurrently design a single system application.

In Step 215, the generator program 28 generates destination directories 138. In this step the generator program 28 ensures that the designer-specified destination directories 138 exist and, if they do not exist, the destination directories 138 are created. In Step 220, virtual directories 142 are generated. In this step the generator program 28 ensures that the designer-specified virtual directories 142 exist and, if they do not exist, the virtual directories 142 are created. In Step 225, the generator program 28 connects to the specified database server 148 and verifies authentication of the system user account that is used by the generator program 28 to dynamically create a database system. In Step 230, the generator program 28 creates a database on the database server 14, including tables, indices, relationships, primary and foreign keys, constraints and security information needed for the generated software application 40. Additional database elements that are well known in the art may also be included in this step.

In Step 235, the generator program 28 creates stored procedure code within the generated database. In Step 240, the generator program 28 generates a persistence tier 158. In this step, persistence controller classes 160 are created for each entity 50 needed for the generation application including, in a preferred embodiment, security and reports. Controller classes are well known in the art as classes within object code that provide logic to a specific entity 50. In accordance with a preferred embodiment, the persistence controller class 160 provides the logic that relates to saving, deleting and retrieving data about specific instances of an entity 50. In Step 245, the generator program 28 generates the presentation tier of the application. In this step, the presentation controller classes 162 are created for each entity 50 needed for the generation application including, in a preferred embodiment, security and reports. In Step 250, the generator program 28 creates the business object code 164 for each entity 50 used in the generated software application 40.

In Step 255, the generator program 28 creates web browser template files 166. The use of web browser template files 166 is well known in the art. In a preferred embodiment, the web browser template files 166 display information within the generated software application 40. In Step 260, the generator program 28 generates the security logic for the end users of the generated software application 40. Various forms of security logic are well known in the art. In a preferred embodiment, the generator program 28 modifies the necessary security files with custom functions and procedures. In Step 265, the generator program 28 generates a project file 168 to connect multiple tiers of the generated software application 40. In a preferred embodiment, the project file 168 is generated as a Visual Basic file. But it will be readily apparent to one of ordinary skill in the art that other software languages that are well known in the art may be used to generate the project file 168.

FIG. 11 is a screen shot that illustrates a GUI that a designer might use to track the generation of a generated software application 40 in accordance with an embodiment of the present invention. A generation status area 170 is shown in the figure that tracks each of the steps described above as the application is generated. Each step is checked as the step is completed in the generation process. The designer may then interactively modify the generated software application 40, customizing the generated system for the end users'specific needs.

Returning to the high-level block diagram of FIG. 2, the generated software application 40 is customized in Step 300. In a preferred embodiment, the application customization process involves several steps. These steps may include direct manipulation or modification of the generated software application 40 to add custom features not included by default through the use of the design program 26 or the generator program 28. Custom code is written at the discretion of the designer. Customization provides the designer with a plethora of features that are routinely available to application programmers, but that are not normally available to web developers. Examples of features that can be added include, but are not limited to automated emails, credit card validation, and language translation.

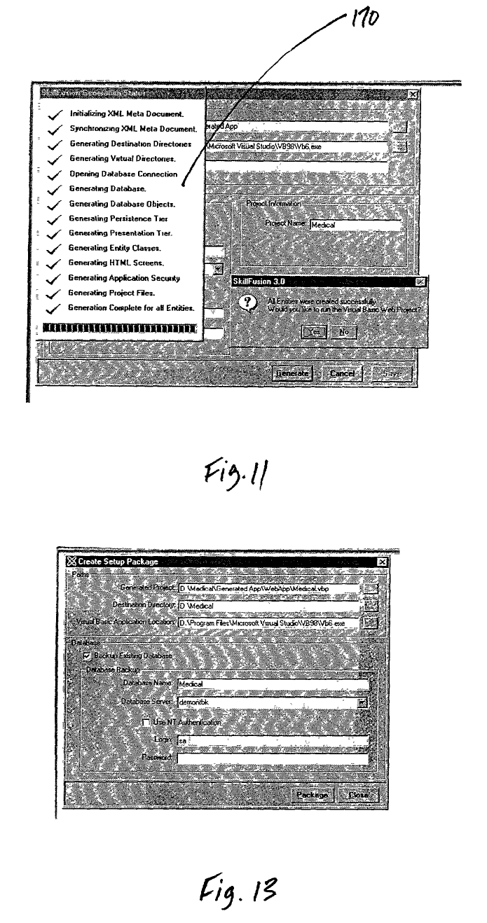

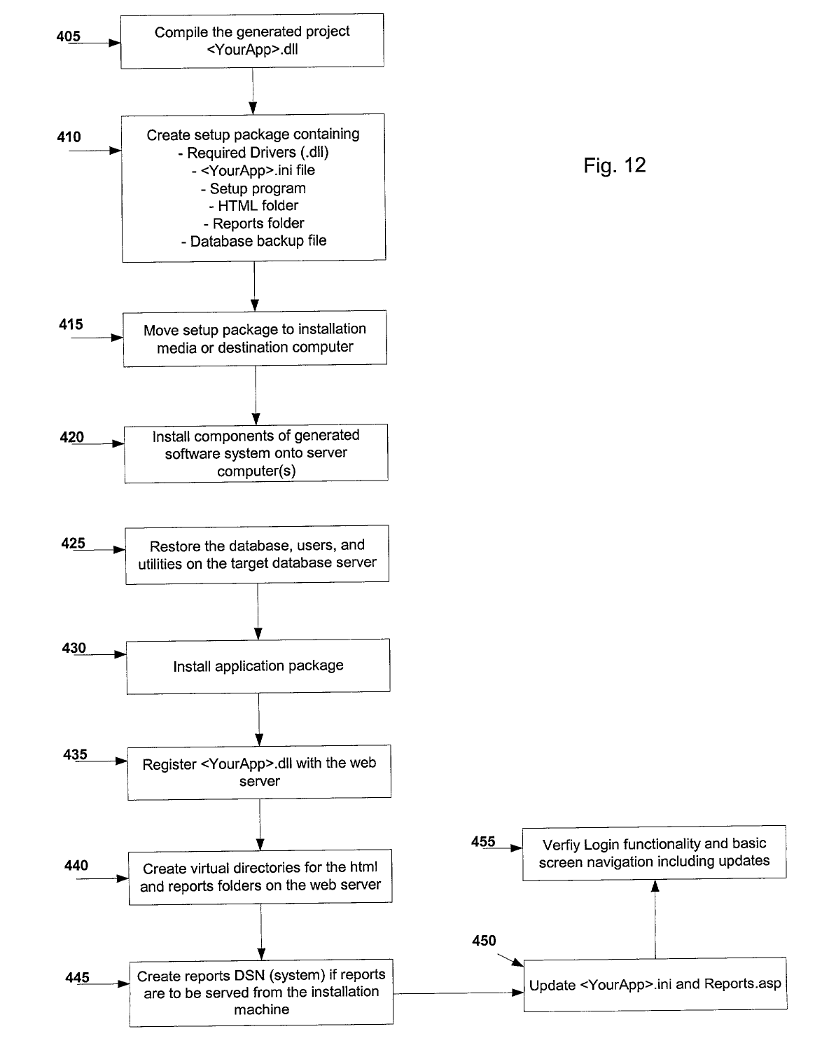

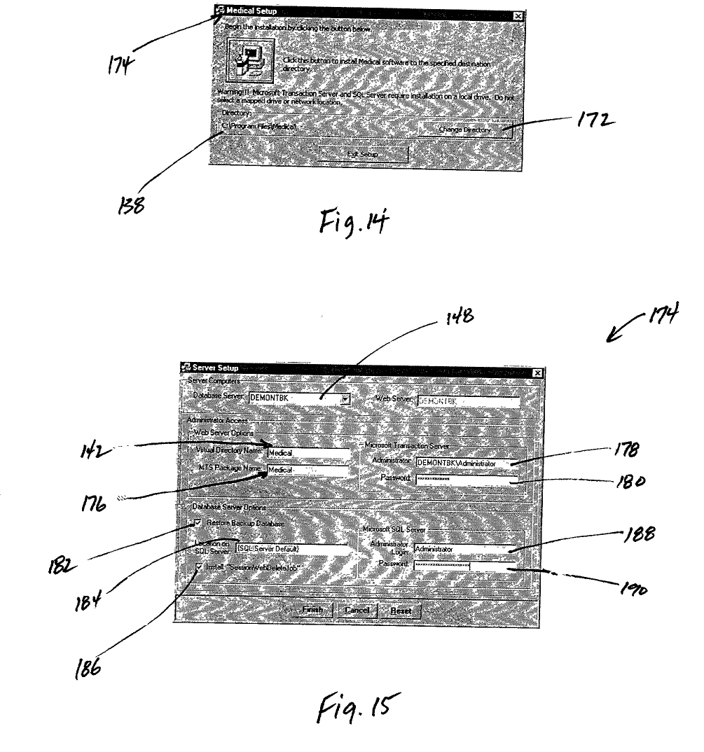

The process of application installation and configuration occurs in Step 400. In a preferred embodiment, the installation and customization process involves several steps, which are illustrated in the block diagram of FIG. 12. Also in a preferred embodiment much of the installation and customization process described below is automated by the compile and configure program 42 and the system installation program 44. FIG. 13 displays a create setup package screen in accordance with an embodiment of the present invention. This screen automates the processes of compiling the generated software application 40 (Step 405) by prompting the designer for typical compile options. It also creates a system installation program 44 for the generated system (Step 410). The setup package registers the compiled application with the web server (Step 435), creates virtual directories for html pages and report folders and creates reporting DSNs as necessary.

In Step 415, the designer is prompted to move the compiled application code and system installation program 44 created by the processes in Steps 405 and 410 to another file directory or transportable medium. In a preferred embodiment, in this step the designer moves the files to one of a production user computer 22, production application server 20 and production database server 18.

In Step 420, the designer installs the components of the generated software system by executing the system installation program 44. FIG. 14 is a screen shot that illustrates a GUI to prompt a designer to run a system installation program 44. In this embodiment, the figure specifies a destination directory 138 for the system components and includes a change destination directory button 172 that allows the designer to change the destination. The figure also includes the caption “Medical Setup, ” 174 which refers to the project name 152 of the generated system.

In Step 425, the system installation program 44 configures the target database server. FIG. 15 illustrates a server setup screen 174 in accordance with an embodiment of the present invention that prompts a designer to configure the generated software system within the server environment. In the disclosed embodiment, the server setup screen includes the name of the database server 148, the name of the virtual directory to be created 142, the name of the MTS package to be created 176, administrator user identification 178, and password 180 fields. In addition, the embodiment illustrated in FIG. 15 also includes database server options such as a restore backup database field 182, a location on the SQL server to reference 184, an install SessionWebDeleteJob field 186, a MicroSoft SQL server identification 188 and corresponding password 190. The MTS package created by the system installation program 44 manages resources when multiple end users are using the application. The virtual directory provides web server access to the generated software system files. Finally, the database server options configure the SQL Server and the generated software system to communicate with each other.

In Step 430, the system installation program 44 configures a generated system program. In a preferred embodiment, the generated system program operates on the application server 16 but it will be readily apparent to one of ordinary skill in the art that the generated system program can operate on another server or on a separate stand-alone electronic device.

In Step 435, the system installation program 44 integrates the application server software with the web server software. In a preferred embodiment, the application server software and the web server software operate on the application server 16, but it will be readily apparent to one of ordinary skill in the art that either or both of the application server software and the web server software can operate on another server or on a separate stand-alone electronic device.

In Step 440, the system installation program 44 creates virtual directories for the web server and reports server software of the generated software system. In a preferred embodiment, the reports software server operates on the application server 16, but it will be readily apparent to one of ordinary skill in the art that the reports server software can operate on another server or on a separate stand-alone electronic device.

In Step 445, the system installation program 44 integrates the reports presentation components of the generated software system with the database server 14 through the use of a system data source name (DSN).

In Step 450, the system installation program 44 connects the application server 16 with the web server through modifications to the ini initialization file for the generated software system. The system installation program 44 also connects the web server to specific report components. In a preferred embodiment, the web server is connected to the report components via modifications to the reports.asp program. In Step 455, the system installation is complete and the user verifies login functionality and basic screen navigation to confirm that the installation was successful and that the generated system is properly configured.

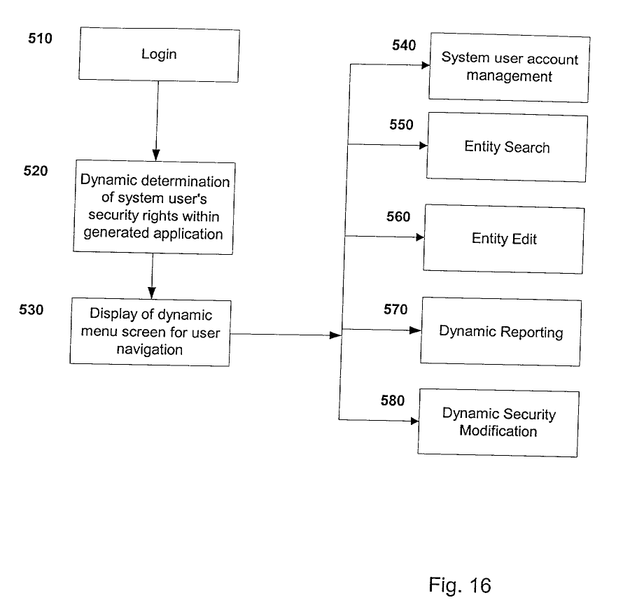

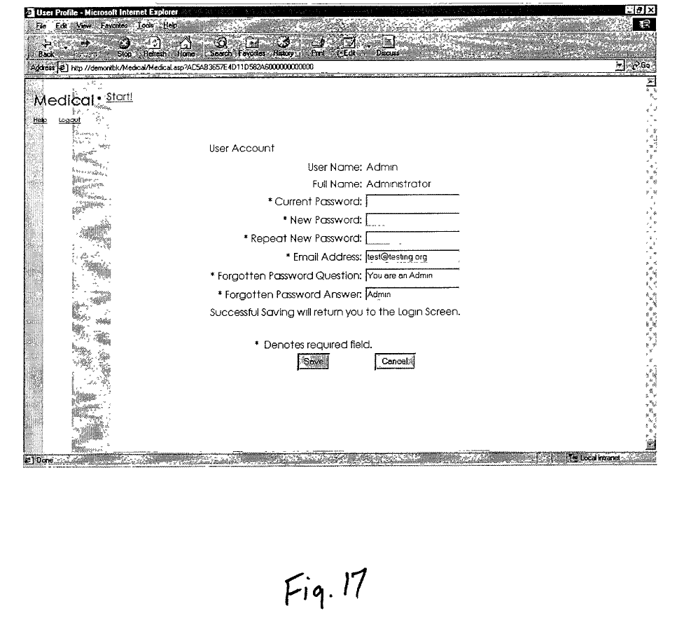

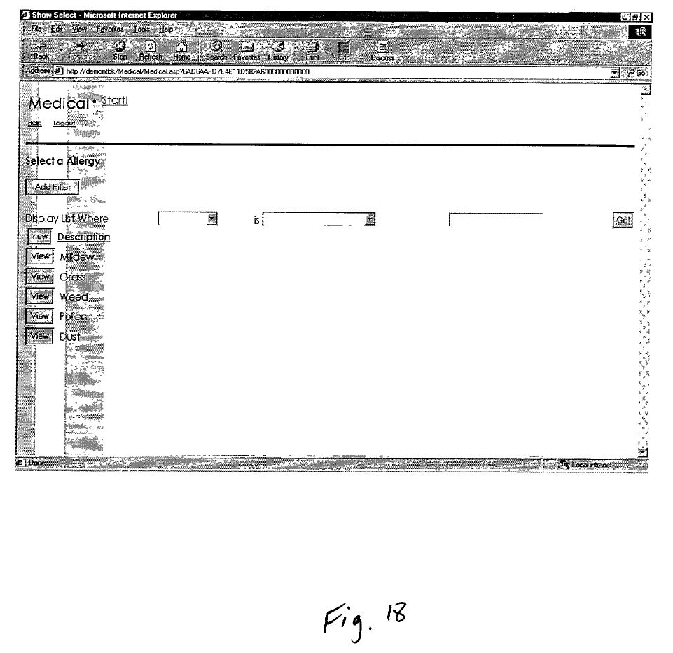

Returning again to the high-level block diagram of FIG. 2, in Step 500 the process of generated software application 40 use occurs. In a preferred embodiment, generated software application 40 use involves several steps, which are illustrated in the block diagram of FIG. 16. In Step 510, the user enters some account criteria to access the generated application 40. In a preferred embodiment, the account criterion is a user identification and password combination. But it will be readily apparent to one of ordinary skill in the art that other system login methods are known in the art and may be employed with the present invention. FIG. 17 illustrates a login screen in accordance with an embodiment of the present invention and prompts the user for an organization, user name and password.

In Step 520, the generated software application 40 validates the user account criteria and determines the user's security rights with regard to the generated application 40.

In Step 530, if the generated software application 40 determines that the user has the appropriate rights to access and use the generated system, the user is presented with a menu in the generated software application 40 GUI. In a preferred embodiment, the menu provides for navigation through the GUI of the generated software application 40. With the appropriate security rights, a user may access features of the generated software application 40. In accordance with an embodiment of the present invention, some of the features that a user might access in a generated software application 40 are described in the following paragraphs.

In Step 540, one or more GUI screens are provided that allow a user to manage a system user account. FIG. 17 illustrates a user account management screen in accordance with an embodiment of the present invention. The account management functions shown FIG. 17 include the ability to change a user account password and/or an email address and to specify a forgotten password question and answer combination. Other user management functions may be readily included in the generation application and are encompassed by the present invention.

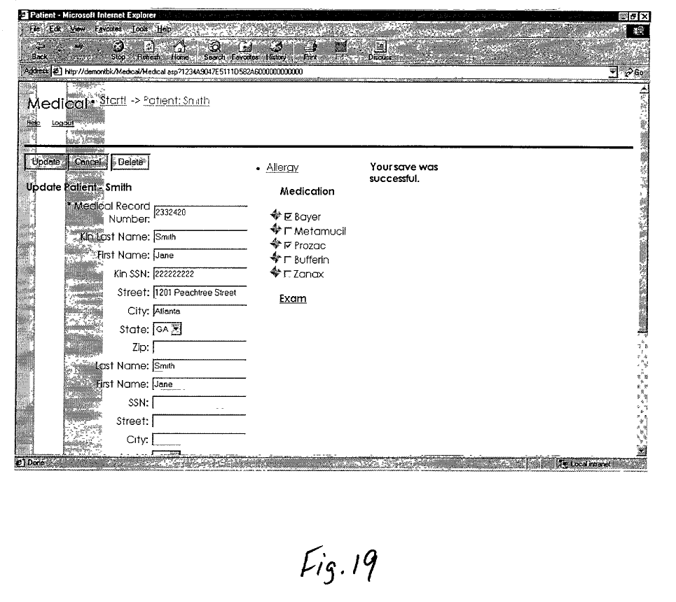

In Step 550, one or more GUI screens are provided that allow a user to search for a specific instance of an entity 50. FIG. 18 illustrates an entity search screen in accordance with an embodiment of the present invention. In the disclosed embodiment, an entity search screen is illustrated that allows a user to search the allergy entity. The syntax for any searches takes the form: Where [Phrase 1] is [Phrase 2] [Phrase 3]. This is the syntax for the recommended SQL used for all databases. Phrase 1 refers to a column of data in the search screen. Phrase 2 is a relationship. Phrase 3 is a value. For instance, an end user may want to view all patient appointments with appointment date of January 31^{st}. Phrase 1, column name, would be the appointment date. Phrase 2, relationship, would be ‘equals’. And the phrase 3, value, would be ‘January 31^{st}’.

In Step 560, one or more GUI screens are provided that allow a user to modify specific instances of a given entity 50. FIG. 19 illustrates an entity edit screen in accordance with an embodiment of the present invention that permits the user to edit an instance of the patient entity. In this illustration, editable fields include medical record number, kin last name, first name, kin social security number, street address, city, state, zip, patient last name, patient first name, patient social security number, patient street address, patient city, state and zip. In addition, the user is prompted to change the medications that the patient is allergic to. In this embodiment, the medications represent medication entities related to the instance of the patient entity that was previously defined within a many to many relationship.

In Step 570, one or more GUI screens are provided that allow a user to perform dynamic reporting in accordance with an embodiment of the present invention. In a preferred embodiment, the dynamic reporting process permits a user to run reports against data stored within the generated system database 32. Many reports generation processes are well known in the art and can be employed with the present invention in Step 570.

In Step 580, one or more GUI screens are provided that allow a user to perform dynamic security modification in accordance with an embodiment of the present invention. In a preferred embodiment, this process is used by administrative system users to set up user account groups within the generated software application 40.

Another aspect of the present invention is the use of dynamic web pages and hook technology. Normally, dynamic web pages are implemented using server-side coding languages such as active server page (ASP) or PHP hypertext preprocessor (PHP). This code is written on text files and placed on a web server. When a reference is made to a server-side code page by a normal web page, the server is expected to be capable of processing this ASP or PHP code. This type of code has several disadvantages. It is dependent on a web server that is capable of processing the code. In addition, this code is not compiled and therefore is too slow for large applications. Further, ASP, PHP and other server-side languages known in the art tend to be difficult languages to use as they are generally obscure and lack an adequate debugging environment.

The present invention avoids a reliance on this type of server-side programming language by placing hook technology directly inside normal web pages. With this method, any web server can manage these pages. In a preferred embodiment, the hook contains an identifying name that indicates to the underlying application how the hook should be processed. A hook is surrounded by a pair of double brackets that distinguish it from normal HTML markup tags. When the page is processed by the web server, the hooks are passed off to the generated application for processing. The generated application determines what data is required for the hook and how it should be displayed, it then returns a formatted HTML document to the web server, which is then sent to the end users' browser. Thus, in accordance with one aspect of the present invention, the designer has the freedom to invent his or her own server-side language.

The software development tool 10 initially generates hooks in web pages and the application code required to process the hooks. But the designer has the capability to enhance this process as necessary. In accordance with an embodiment of the present invention, a designer determines what hooks are formatted and how they are processed by the visual basic application. Essentially, the designer has the flexibility to instruct the application to process hooks that match a given pattern in a predetermined manner. In one embodiment, Visual Basic is used because it is a commonly known language with a sophisticated debugging environment and a broad range of technical support and third party add-ins. Visual Basic is also advantageous because it is an easier language in which to perfect and extend an application than server-side languages that are commonly used. However, one of ordinary skill in the art will recognize that the use of hook technology can be readily implemented using other software languages known in the art.

Another aspect of the present invention is the management of a software application that is extended across multiple computers. Traditionally, communication over a network 24 must be managed carefully because data loss during communication can cripple an application. Two known technologies for managing communication between computers are the distributed component object model (DCOM) and the common object request broker architecture (CORBA). In contrast, the present invention employs a new technology known as shuttling. The shuttle takes visual basic objects and serializes them into a string of text. Serializing is a method whereby a three dimensional object structure is flattened out into a two dimensional structure that can be written out as text. This string is then passed character by character from a first computer to a second over the network 24. The receiving computer rebuilds the original object from the serialized text. When it is done processing this information, it serializes the visual basic object once more and passes it back to the originating computer. In a preferred embodiment, this is a unique implementation of Java Enterprise programming methodology in a Visual Basic environment.

Another aspect of the present invention is the systematic implementation of an object-oriented three-tier architecture. In a preferred embodiment, this structure is applied to generated entities 50. As a non-limiting example, for any given entity 50 there is a controller object, a data object, and two presentation objects. The first controller object is the business class. It is aware of all the data relevant for the instance, and has methods used to make calls to a client controller. The second class is the database controller. This class is responsible for communication between the code and the database. Each database controller has access to the database, and has methods for information retrieval and integration to other components of the application. The remaining controller objects handle the application presentation.

The client controller is responsible for rendering of business objects for an edit screen. It checks for permissions, applies them appropriately, and displays (by default) all of the data for an instance of an entity 50. In a preferred embodiment, customizing the format of an edit screen is done through a HTML file associated with the entity 50.

In a preferred embodiment, additional functionality can be easily added to the client controller if the default functionality is not robust enough for the user or designer. Also in a preferred embodiment, a designer has access to the controllers for other entities. This enables the designer to have multiple entities' information on one page, if desired. Further, in a preferred embodiment, multiple instances of an entity 50 may be visible. Presentation tiers use the hooks in the HTML files to place dynamic information on the web screens and to some extent this separates the HTML code from the Visual Basic code.

Another presentation tier object is the show select controller. This object has the responsibility of showing a list of instances of an entity 50, and allows the end user to sort and filter on an arbitrary number of criteria. In a preferred embodiment, the maximum number of criteria is set to 10, but it will be readily apparent that this value is a constant that is easily changed. The show select is totally customizable as a result of structured programming. In a preferred embodiment, a designer or user may modify the show select of the given entity by changing the show select HTML file for the entity 50 and the show select controller.

Another aspect of the present invention is a system design that allows ready integration with third-party reporting software. Reports can be added to the system without necessitating coding changes. In a preferred embodiment, the system development tool 10 generates report management screens and may restrict access to any report based upon user group permissions and the report group to which a report belongs. In a preferred embodiment, generated screens include screens for the report entity, the report parameter entity, the report group entity, and the report switchboard. In a preferred embodiment, the report switchboard is a dynamic screen to launch reports. Moreover, in a preferred embodiment, every generation produces sixteen different classes and eight HTML files devoted to reports.

In a preferred embodiment, there are four report entities, including report, reportparamater, reportgroup, and reportswitchboard. The report entity represents a single report in the database. The report table in the database stores the filename of the actual report, and the URL needed to access the report. For report intensive applications, this allows the use of multiple report servers.

In a preferred embodiment, each report is assigned to a specific report group. Similarly, each user is a member of a certain user group. The user's permissions are based on the group to which he or she belongs and each report group has a permission that corresponds to it. In a preferred embodiment, a user can see only those reports that belong to report groups to which the user's user group has permissions.

In addition, the system provides for reports with parameters. The parameters are stored in the database, and can be added to a report without necessitating changes to the code. This permits reports to be created after a system has been compiled without interrupted uptime. Thus, in a preferred embodiment a designer only needs to add the parameters (after adding the report) to the database using generated screens and to add the report file to the report directory.

Another aspect of the present invention is a system and method for handling collision errors. Database applications are typically susceptible to collision errors. Unless handled correctly, collisions can cripple an application. As is well known in the art, a collision occurs when two users retrieve the same version of a record for modification and both users attempt to modify and save their copy of the record. When this happens, each user's updated copy of the record collides as the users attempt to save the records to the database. Another problem is the situation where one user has successfully saved an updated copy of a record to the database and another user that has previously checked out a copy of the record from the database is left with an outdated version of the record. In this instance, it is possible for an outdated user to save an outdated copy of the record to the database and thereby overwrite the information updated by the first user. Further, this problem can and does occur even if neither user updates the record and only attempts to save a record to the database.

In accordance with an embodiment of the present invention, a method of key generation is disclosed that is completely database independent. Databases known in the art including, as a non-limiting example, Microsoft Access, SQL Server, and Oracle permit a database to perform key generation. However, this results in a program database that is dependent and inflexible. To allow generated applications to perform well regardless of the database platform, the present invention has the generated software application 40 generate its own key indexes. A key generation table is used for this purpose. The key generation table has an entry for each entity 50 in the generated software application 40 and stores the next key needed for that entity 50. When adding new records to an entity's table, the system checks the key generation table for the next key for that entity 50. The generated software application 40 then updates the key generation table with the next sequential key and stores the new record with the retrieved key.

The software development tool 10, which comprises an ordered listing of selectable services can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Further, any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

In concluding the detailed description, it should be noted that it will be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

That which is claimed:

1. A method for automatically generating a software application on a first computer, comprising:
defining a system design;
creating a design database file associated with said system design;
converting said design database file to a meta document;
generating an installation program from said meta document; and
installing at least part of said software application by executing said installation program.

2. The method of claim 1, further comprising transmitting said installation program from said first computer to a second computer.

3. The method of claim 1, wherein generating an installation program from said meta document comprises creating a setup package to automate at least part of an installation and a customization of said software application.

4. The method of claim 1, wherein generating an installation program from said meta document comprises creating one or more files to allow said software application to be installed on a second computer.

5. The method of claim 1, further comprising configuring and customizing said software application.

6. The method of claim 1, wherein defining a system design comprises defining a first entity and at least one attribute associated with said first entity.

7. The method of claim 6, further comprising:
defining a second entity; and
defining a relationship between said first and second entities.

8. The method of claim 6, further comprising:
defining a second entity; and
defining a predefined search associated with at least one of said first and second entities.

9. The method of claim 1, wherein installing said software application comprises:
configuring a target database server; and
establishing communication between said target database server and at least one generated software application file.

10. The method of claim 9, wherein installing at least part of said software application further comprises installing reports server software on an application server.

11. The method of claim 9, wherein installing at least part of said software application further comprises installing application code to create and update a key generation table.

12. The method of claim 9, wherein installing at least part of said software application further comprises providing a web server access to said at least one generated software application file.

13. The method of claim 9, wherein installing at least part of said software application further comprises placing at least one hook in at least one web page and installing application code to process said at least one hook.

14. A system for developing a computer-generated software application, comprising:
a designer computer;
a design application residing on said designer computer, said design application configured to receive a system design and create a design database file;
a generator application in communication with said design application, configured to receive said design database file and generate said computer-generated software application, wherein said computer-generated software application includes a presentation tier, a business tier and a data tier.

15. The system of claim 14, wherein said system design comprises at least one entity and at least one attribute associated with said entity.

16. The system of claim 14, wherein said system further comprises a design database configured to receive and store said design database file.

17. The system of claim 14, wherein said generator application is configured to convert said design database file into an extensible markup language file.

18. The system of claim 17, wherein said computer-generated application is programmed with object technology.

19. A method for generating a software application, comprising:
receiving system design, wherein said system design defines at least one entity;
generating destination directories;
generating virtual directories;
establishing database connections;
creating procedure code;
creating controller classes, said controller classes providing logic for said at least one entity;
creating object business code for said at least one entity;
creating at least one web browser template file;
generating security logic; and
generating a project file.

20. The method of claim 19, wherein receiving said system design comprises receiving an extensible markup language file associated with said system design.
